(19) United States
(12) Patent Application Publication
(10) Pub. No.: US 2012/0237658 A1
(43) Pub. Date: Sep. 20, 2012

(54) OXIDATIVELY STABLE FATS WITH ELEVATED ALPHA-LINOLENIC ACID CONTENT

(75) Inventors: Diliara Iassonova, Fort Collins, CO (US); Linsen Liu, Irvine, CA (US)

(73) Assignee: Cargil, Incorporated, Wayzata, MN (US)

(21) Appl. No.: 13/395,046

(22) PCT Filed: Sep. 10, 2010
(86) PCT No.: PCT/US10/48505

§ 371 Date: May 24, 2012

Related U.S. Application Data
(60) Provisional application No. 61/241,176, filed on Sep. 10, 2009.
(60) Provisional application No. 61/357,978, filed on Jun. 23, 2010.

(51) Int. Cl. A23D 9/06

(52) U.S. Cl. 426/541; 426/601

(57) ABSTRACT

The present disclosure provides edible, non-hydrogenated fats with good oxidative stability despite elevated levels of α-linolenic acid (ALA). In one implementation, such a fat has at least 7.5 wt % ALA, no more than 10 wt % saturated fatty acids, and an OSI at 110° C. of at least 25 hours.

### TECHNICAL FIELD

The present disclosure relates generally to edible fats and food products made with edible fats. More particularly, the present disclosure describes edible fats that are oxidatively stable even though they have elevated levels of omega-3 fatty acids, e.g., α-linolenic acid. Food products made with such fats, particularly baked food products and other food products in which the fats are heated, exhibit surprisingly long shelf life.

### BACKGROUND

Consumers are paying increasing attention to not only the total fat content in food products, but also the nature of those fats. In general, foods low in saturated fats and trans-fats are viewed as healthier. Consumers also perceive some health benefits in increasing the levels of omega-3 fatty acids in one's diet.

Omega-3 fatty acids, also referred to as n-3 fatty acids, are unsaturated fatty acids having a carbon-carbon double bond in the third position. From a nutritional standpoint, the most important omega-3 fatty acid moieties are probably α-linolenic acid (ALA), eicosapentaenoic acid (EPA), and docosahexaenoic acid (DHA). ALA is an 18-carbon fatty acid moiety having three carbon-carbon double bonds (commonly referred to as C18:3 in shorthand notation), one of which is at the n-3 position. EPA is a 20-carbon fatty acid moiety having 5 carbon-carbon double bonds (C20:5) and DHA is a 22-carbon fatty acid moiety having 6 carbon-carbon double bonds (C22:6).

Generally, the oxidative stability of a fatty acid decreases as the number of double bonds, or the degree of unsaturation, increases. Unfortunately, ALA, EPA, and DHA are all polyunsaturated fats that tend to oxidize fairly readily, with EPA being more prone to oxidation than ALA and DHA being more prone to oxidation than either ALA or EPA. As a consequence, increasing the omega-3 content tends to reduce the shelf life of many food products.

### BRIEF DESCRIPTION OF THE DRAWINGS

FIG. 1 is a graph showing oxidative stability as a function of ALA content for edible fats in accordance with an embodiment of the disclosure.

FIG. 2 is a graph showing oxidative stability as a function of ALA content for edible fats in accordance with another embodiment of the disclosure.

### DETAILED DESCRIPTION

### Overview

Specific details of several embodiments of the disclosure are described below. One aspect of the present disclosure is directed toward an edible, non-hydrogenated fat having at least 7.5 weight percent (wt %) α-linolenic acid (ALA), no more than 10 wt % saturated fatty acids, and an Oxidative Stability Index at 110° C. (OSI) of at least 25 hours.

Another aspect of the disclosure provides an edible fat comprising a combination of a) rapeseed oil having at least 65 wt % oleic acid, b) flaxseed oil, and c) an antioxidant. This fat has an OSI of at least 25 hours and it contains at least 7.5 wt % ALA and no more than 10 wt % saturated fatty acids.

This disclosure also describes food products containing edible fats. One such food product includes an edible, non-hydrogenated fat having at least 7.5 wt % ALA, no more than 10 wt % saturated fatty acids, and an OSI of at least 25 hours. The food product may comprise at least 160 mg of ALA, desirably at least 320 mg of ALA, per 50 g or per 40 g of the food product.

Unless otherwise indicated, all numbers expressing quantities of ingredients, properties such as molecular weight, percentages, reaction conditions, and so forth used in the specification and claims are to be understood as being modified by the term “about.” Accordingly, unless indicated to the contrary, the numerical parameters set forth are approximations that may depend upon the desired properties sought.

### Edible Fats—Components

Embodiments of the disclosed edible fats include a first fat, which in some embodiments has at least 63 wt % oleic acid; a second fat that includes ALA; and, preferably, an antioxidant. Suitable components are described below.

### A. High Oleic Acid First Fat

The first fat is an edible fat and may be relatively high in oleic acid, typically including at least 63 wt % oleic acid. Oleic acid is a monounsaturated 18-carbon acid moiety commonly referred to as C18:1. In select embodiments, the first fat includes at least 65 wt %, e.g., 67 wt % or more, oleic acid, with select implementations including at least 70 wt %, e.g., 73 wt % or more, 75 wt % or more, or even 80 wt % or more, oleic acid. In one useful embodiment, the first fat comprises a rapeseed oil comprising 67 wt % or more, e.g., 70-80 wt % or 73-80 wt %, oleic acid (In the compositions described herein, the stated fatty acid percentages are based on the total weight of fatty acid moieties in the fat and may be determined using AOCS Official Method Ce 1c-89.)

The first fat may also be relatively low in saturated fatty acids, preferably no more than 12 wt % saturated fatty acids. For example, the first fat may contain 10 wt % or less, e.g., 9 wt % or less, 7 wt % or less, or even no more than 5 wt %, saturated fatty acids. Use of a first fat with lower saturated fatty acid content can reduce the total amount of saturated fat in the edible fat composition, particularly if the edible fat composition includes more of the first fat than the second fat. Although the first fat may be partially hydrogenated, a non-hydrogenated oil is preferred for many applications as it will limit the content of both saturated fat and trans-fats. As noted above, lower total saturate fat and trans-fat contents have positive health connotations in consumers' minds. For other food applications that require a structured fat, though, it may be advantageous to include a hydrogenated or partially hydrogenated oil.

Even though the edible fat of this disclosure desirably includes a relatively high (e.g., at least 10 wt %) level of ALA, the first fat may be relatively low in ALA. In some embodiments, the first fat comprises no more than 5.0 wt % ALA, e.g., no more than 4.0 wt % or no more than 3.5 wt % ALA, with some useful embodiments employing a first fat having no more than 3.0 wt % ALA.

In some implementations, the first fat desirably has no more than 20 wt %, preferably no more than 18 wt %, e.g., 15 wt % or less, linoleic acid, which is an 18-carbon acid moiety with two carbon-carbon double bonds commonly referred to as C18:2. In some embodiments, the first fat includes no more than 12 wt % linoleic acid, e.g., less than 10 wt % or less than 8 wt % linoleic acid. Lower levels of linoleic acid in edible fats of the invention are believed to promote oxidative stability.

Although the first fat may come from a variety of fat sources, e.g., algal oils, in one embodiment the first fat is, or at least includes, a vegetable oil. Typically this oil will be commercially refined, bleached, and deodorized, though a less-processed oil such as a cold-pressed oil may be used instead. In a preferred embodiment, the first fat is rapeseed oil, which encompasses what is commonly called “canola” oil in North America. Suitable rapeseed oils meeting the above-specified criteria are commercially available from Cargill, Incorporated of Wayzata, Minn., USA under the CLEAR VALLEY® trademark, such as CLEAR VALLEY® 65-brand (“CV65”) or CLEAR VALLEY® 75-brand (“CV75”) canola oils. High-oleic sunflower oil (e.g., CLEAR VALLEY® brand) and high-oleic, low-linolenic soybean oil (e.g., oil from PLENISH brand HOLL soybeans developed by Pioneer Hi-Bred International of Johnston, Iowa) may also suffice for some specific applications. The first fat may be a single type of fat, e.g., rapeseed oil, or a blend of oils, e.g., rapeseed and high-oleic sunflower oil.

### B. High-ALA Second Fat

Edible fats disclosed herein may employ a second fat that is both edible and non-hydrogenated. The second fat has more ALA than does the first fat and may have less oleic acid than the first fat (both on a fatty acid moiety weight basis).

The second fat desirably has at least 30 wt % ALA, desirably at least 40 wt % ALA. In some preferred embodiments, the second fat includes at least 45 wt % ALA, e.g., 45-75 wt % or 45-60 wt % ALA. Edible fats known to have such high ALA contents include those derived from specific algae, plants, and animals, especially marine animals. Marine oils, however, may have higher levels of EPA and/or DHA that can degrade oxidative stability and may adversely impact sensory aspects of some packaged food products.

For a number of applications, the second fat is plant-derived. Suitable sources are believed to include seeds of flax, kiwifruit, chia (Salvia hispanica), perilla (Perilla fruitescens), and lingonberry (Vaccinium vitis-idaea). In select implementations, the second fat comprises flaxseed oil or chia oil, preferably flaxseed oil. Flaxseed oil is commercially available from a variety of sources, including Bioriginal Food & Science Corp. of Saskatoon, Saskatchewan, Canada and Heartland Flax of Valley City, N.D., USA. Flaxseed oils having ALA contents over 60 wt %, e.g., 75 wt % or more, are commercially available from Polar Foods, Inc. of Fisher Branch, Manitoba, Canada under the brand name HIOMEGA. Particularly if flaxseed oil is used, it may be advantageous to employ a cold-pressed oil or a solvent-extracted oil that has not been subjected to the full commercial refining, bleaching, and deodorizing process.

As noted above, EPA and DHA are omega-3 oils, but they tend markedly decrease oxidative stability. To improve stability of the final edible fat, the second fat desirably includes no more than 0.1 wt % EPA and no more than 0.1 wt % DHA. More preferably, the second fat includes no detectable amount of EPA moieties and/or DHA moieties using AOCS Official Method Ce 1c-89.

### C. Hard Fats

As discussed below, some embodiments of the invention provide structured fats, such as shortenings, that require more solid fat content, e.g., at 10° C. The solid fat content in such structured fats may come from partially hydrogenating the first fat. Partial hydrogenation can increase trans-fat content, though. More desirably, the solid fat content is provided by adding a third fat that has sufficient saturated fat to provide the final edible fat with the desired structure and/or plastic consistency.

The third fat may comprise a fat that is naturally high in saturated fats, such as cottonseed oil, palm oil, palm kernel oil, or the like, or hard stock fractionated from such oils, such as fractionated palm kernel oil. The third fat may instead be a fully hydrogenated fat, which may have >85 wt % or >90 wt % saturated fat. Such fully hydrogenated fats have very few double bonds, so they will add little or no trans-fat to the final edible fat. The first fat and the hydrogenated third fat may the same type of fat, e.g., the first fat may comprise CV65 or CV75 canola oil and the third fat may comprise a fully hydrogenated rapeseed oil. In other implementations, though, the first and second fats may be different types of fat, e.g., the first fat may comprise CV65 or CV75 canola oil and the third fat may comprise hydrogenated soybean oil or cottonseed oil.

### D. Antioxidant

Edible fats of this disclosure optionally include at least one antioxidant. Any of a wide range of antioxidants recognized for use in fats and other foods are expected to work well, including tertiary butylhydroquinone (TBHQ), butylhydroxyanisole (BHA), butylhydroxytoluene (BHT), Vitamin E and other tocopherols, rosemary extract, or selected polyamines (see, e.g., U.S. Pat. No. 6,428,461, the entirety of which is incorporated herein by reference). Such antioxidants may be used alone or in combination. One rosemary extract-based antioxidant is commercially available from Kalsec, Inc. of Kalamazoo, Mich., USA under the trade name DURALOX; as described in U.S. Pat. No. 5,296,249, the entirety of which is incorporated herein by reference, such a rosemary extract-based antioxidant may also include ascorbic acid. In one implementation that has been found to work well, the antioxidant comprises TBHQ.

### Edible Fats—Properties

### A. Generally

Edible fats in accordance with aspects of this disclosure may include at least 6 wt %, preferably at least 7.5 wt %, ALA. Desirably, the edible fats have an ALA content of at least 9 wt %, e.g., at least 10 wt %, and preferably at least 15 wt % or at least 20 wt %. Some preferred embodiments have 9-40 wt %, e.g., 10-35 wt % or 15-30 wt %, ALA.

The amount of ALA in the edible fat will depend in part on the nature and relative percentages of the first and second fats, with ALA content increasing as the amount of the second fat is increased. The precise combination of first and second fats, and the resultant ALA content, useful in any given application will depend on a variety of factors, including desired shelf life, flavor profile, and the type of food application for which the edible fat is intended. With the present disclosure in hand, though, those skilled in the art should be able to select suitable combinations of the identified first and second fats for a particular application.

As explained previously, saturated fats and trans-fats have negative health connotations. Certain edible fats of the disclosure, therefore, may have relatively low levels of such fats. For example, some useful implementations have less than 12 wt % saturated fat, preferably no more than 10 wt %, e.g., no more than 9 wt % or no more than 8 wt %, saturated fat. In certain applications, the edible fat may have less than 7 wt %, desirably less than 5 wt %, saturated fat. Although most commercially refined, bleached, and deodorized vegetable oils will contain some minor level of trans-fat, the edible fat desirably includes no more than 3.5 wt % trans-fat, preferably no more than 3 wt %, e.g., 0-2 wt %, trans-fat.

In some implementations, the edible fat is pourable at room temperature. For example, the oil may have a solid fat content (“SFC”, determined in accordance with AOCS Cd 16b-93) of no more than 20%, e.g., no more than 12% or no more than 10%, at 10° C. Such fats may be used in a variety of applications that call for a liquid oil. Low saturated fat contents such as those noted in the preceding paragraph are well-suited for such pourable edible fats.

In other applications, however, the edible fat may be a structured fat that is solid or semi-solid at room temperature. Structured fats in accordance with such embodiments may have a SFC of more than 15%, e.g., at least 20%, at least 25%, at least 30%, at least 35%, or at least 40%, at 10° C. Such fats may be useful in applications that call for shortenings, such as an all-purpose shortening. To make such a structured fat, it may be necessary to either partially hydrogenate the first fat or, more desirably, add a hard fat as a third fat. As noted above, such a hard fat may comprise an oil that is naturally high in saturated fats, such as palm or cottonseed oil or fractions thereof, or a hydrogenated fat. Methods of producing structured fats having the desired structural and functional properties, which may include blending, cooling (e.g., votating), and/or annealing, are well known in the art and need not be detailed here.

The edible fat desirably includes no more than 0.1 wt % EPA and no more than 0.1% DHA. More preferably, the edible fat includes no detectable amount of EPA moieties and/or DHA moieties using AOCS Official Method Ce 1c-89.

### B. Oxidative Stability

Oxidative stability depends on many factors and cannot be determined by fatty acid profile alone. It is generally understood, though, that ALA and other omega-3 fatty acids tend to oxidize more readily than oleic acid and other more saturated fatty acids. On a relative oxidative stability scale, linoleic acid is significantly more stable than ALA, oleic acid is significantly more stable than linoleic acid, and saturated fatty acids are even more stable than oleic acid.

Oxidative stability can be measured in a variety of ways. As used herein, though, oxidative stability is measured as an Oxidative Stability Index, or OSI, at 110° C. with a 743 RANCIMAT® analyzer (Metrohm AG, Herisau, Switzerland) generally in accordance with American Oil Chemists' Society test protocol AOCS Cd 12b-92, except that the sample size of the oil is 3.0 g.

Edible fats of this disclosure exhibit notably high oxidative stability despite their relatively high ALA levels. Particularly surprising for some embodiments is that these high oxidative stabilities have been achieved without increasing saturated fat contents to unacceptable levels in an effort to compensate for the increased ALA content.

Currently, manufacturers of fish oils, which contain EPA and DHA, take extraordinary measures to protect the oil from oxidation. One common technique, referred to as microencapsulation, is a complex process that involves trapping very small droplets or particles in a shell, which may be formed of starches, gelatins, proteins, or polymers. See, for example, published US Patent Application Publication No. 2006/0068019. Sometimes such microencapsulated oils are further encapsulated in larger shells that enclose clusters of the microencapsulated oils.

Edible fats in accordance with aspects of the invention can be used and stored as bulk oils, i.e., without such encapsulation. The superior oxidative stability of these edible fats make encapsulation unnecessary for many purposes. This significantly simplifies production, handling, and use of the edible fat and makes the edible fat more cost-effective.

### C. Select Embodiments

In one commercially useful aspect of the present disclosure, the first fat is rapeseed oil and the second fat is flaxseed oil. More specifically, the rapeseed oil may comprise refined, bleached, and deodorized canola oil derived from Brassica napus seeds and may contain at least 65 wt % oleic acid, no more than 4 wt % ALA, and no more than 20 wt % linoleic acid. The flaxseed oil is desirably food grade, such as that available from Bioriginal Food & Science Corp., and contains at least 40 wt %, e.g., 45-60 wt %, ALA; cold-pressed flaxseed oil has proven to work well.

The edible fat is desirably a combination of between 35 wt % and 90 wt %, preferably 40-85 wt % or 44-75 wt %, of the rapeseed oil and between 10 wt % and 65 wt %, preferably 15-60 wt % or 25-56 wt %, flaxseed oil. With the addition of 200 ppm TBHQ, such blends have yielded OSI values greater than 25 hours, e.g., at least 28 hours, with many such blends exceeding 30 hours.

In one particularly useful embodiment, the edible fat comprises a combination of 75-85 wt % of rapeseed (canola) oil and 15-25 wt % flaxseed oil. This particular canola oil contains at least 70 wt %, e.g., at least 72 wt % or at least 75 wt %, oleic acid and no more than 4 wt %, preferably no more than 3.5 wt %, ALA. As discussed below, testing has shown that such a blend with 200 ppm TBHQ has a surprisingly stable OSI value over that blend range.

### Food Products

Aspects of this disclosure allow formulation of food products with relatively high levels of ALA without unduly sacrificing shelf life. In one implementation, food products of the disclosure contain at least 160 mg of ALA, desirably at least 320 mg of ALA, per 50 g of the food product.

Some embodiments provide food products comprising edible fats in accordance with the preceding discussion. The edible fat may be incorporated in the food product in any conventional fashion. For example, the food product may comprise a fried food (e.g., French fries or donuts) fried in the edible fat.

In other instances, the edible fat may be mixed with other ingredients of the food product prior to cooking, e.g., to supply some or all of the fat requirements for a batter or the like for a baked food product. Edible fats in accordance with the disclosure have proven very useful in food products that are cooked with the edible fat included, e.g., by incorporating the edible fat in an uncooked product that is cooked to produce the final food product. In baked goods, for example, uncooked product may be a batter or dough that incorporates the edible fat and the uncooked product may be cooked at a temperature of at least 350° F. (e.g., at least 375° F. or at least 400° F.) for at least 10 minutes (e.g., at least 15 minutes or at least 20 minutes). Edible fats in accordance with this disclosure have proven to withstand the challenging environment of such cooking to provide cooked food products, including baked food products, with both elevated ALA contents and commercially desirable stability and shelf life.

In still other instances, the edible fat may be an ingredient in a food product or a component thereof that does not need to be cooked. In such applications, the edible fat is not subject to the rigors of high-temperature processing. In one such application, the edible fat may be used as a bakery shortening (e.g., a liquid shortening, a solid shortening, or a semi-solid shortening) for use in fillings, icings, or the like. In another such application, the edible fat may be sprayed on the food product as a coating, e.g., as a coating applied to crackers, chips, pretzels, cereal products (e.g., ready-to-eat cereals or cereal bars), nuts, or dried fruits.

Knowing the desired fat content of a given food product, the composition of the edible fat may be adjusted to yield a desired ALA content in the food product. For example, the US Food and Drug Administration allows food manufacturers to identify a food product as a “good” source of omega-3 fatty acids if it contains at least 160 mg of omega-3 fatty acids per serving and as an “excellent” source if it contains at least 320 mg of omega-3 fatty acids per serving. In one embodiment, food products of the invention may meet one or both of these criteria without unduly impacting shelf life.

The US FDA sets a “reference amount” for determining an appropriate serving size for a given food product in the US, with the reference amount varying from one type of food product to another. As used herein, the term FDA Reference Serving Size for a given food product is the “reference amount” set forth in 21 CFR §101.12 as of 1 Sep. 2009. For example, the FDA Reference Serving Size for grain-based bars such as granola bars is 40 g, for prepared French fries is 70 g, and for snack crackers is 30 g.

By way of example, a food manufacturer may intend to produce a grain-based bar. If the bar includes 1 g of the present edible fat per 40 g FDA Reference Serving Size, an edible fat having 16 wt % ALA (e.g., sample B4 in Example 2 below) would contribute 160 mg of omega-3 fatty acids per serving, permitting the “good source” designation on the packaging for the bar. If the bar instead includes 2 g of the same edible fat per serving, the bar could be designated as an “excellent source” of omega-3 fatty acids. Similarly, a bar could be labeled as a “good source” of omega-3 fatty acids if it contains 1.5 g of an edible fat of the disclosure having 11 wt % ALA (e.g., sample B2 in Example 2 below) per serving. With the oxidative stabilities of the present edible fats, such food products should have excellent shelf lives despite their high ALA contents.

### EXAMPLES

### Example 1

### Canola/Flaxseed Blends

A series of samples were prepared with varying ALA contents, as set forth in Table 1. One sample was CLEAR VALLEY® 75-brand canola oil (CV75 in Table 1); another was conventional cold pressed flaxseed oil (CFSO in Table 1) that contained over 50 wt % ALA; and the remaining 6 samples (A1-A6 in Table 1) were combinations of these two oils in different weight percentages as set forth in the table.

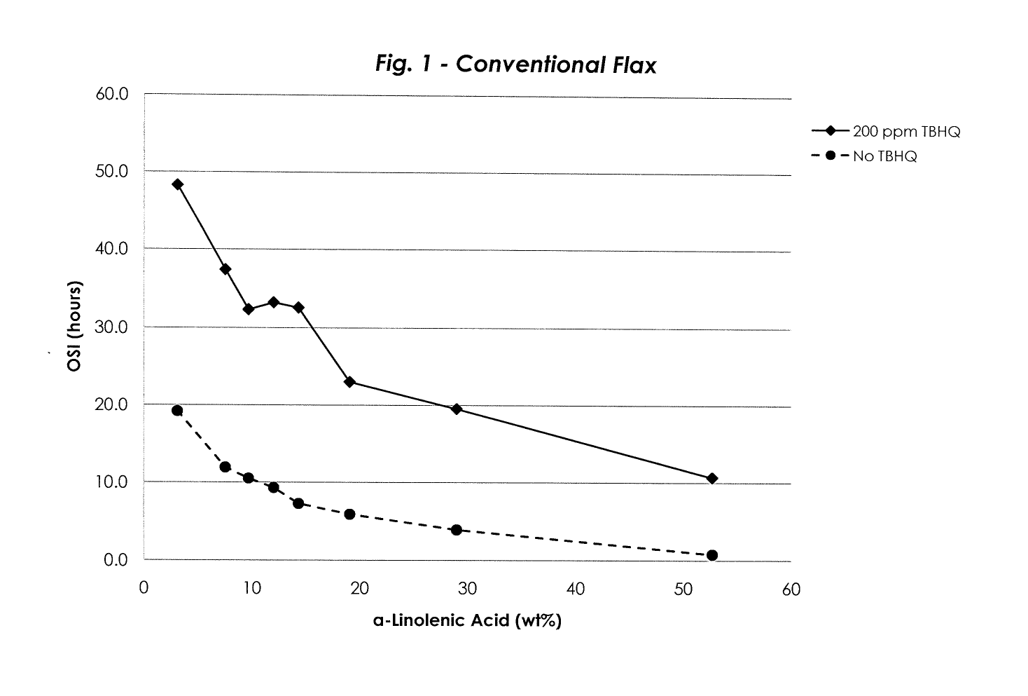

The OSI value for each of these 8 samples was measured without any added antioxidants (“Oil only” in Table 1). A portion of each remaining sample was mixed with TBHQ at a concentration of 200 ppm and the OSI of this second set of samples (“With TBHQ” in Table 1) was measured. As noted above, the OSI measurements were carried out in accordance with AOCS Cd 12b-92 at 110° C. with a 743 RANCIMAT® analyzer, but with a 3 g sample size. The results of the OSI tests are set forth in Table 1 and illustrated graphically in FIG. 1, which plots OSI value against the ALA content of the edible fat.

TABLE 1

| | CV75 | CFSO | ALA | OSI (hours) | OSI (hours) |
|---|---|---|---|---|---|
| Sample | (wt %) | (wt %) | (wt %) | Oil only | With TBHQ |
| CV75 | 100 | 0 | 3.1 | 19.2 | 48.3 |
| A1 | 90 | 10 | 7.6 | 12.0 | 37.4 |
| A2 | 85 | 15 | 9.7 | 10.5 | 32.3 |
| A3 | 80 | 20 | 12.0 | 9.3 | 33.2 |
| A4 | 75 | 25 | 14.3 | 7.3 | 32.6 |
| A5 | 65 | 35 | 19.1 | 5.9 | 23.0 |
| A6 | 44 | 56 | 29.0 | 3.9 | 19.5 |
| CFSO | 0 | 100 | 52.7 | 0.8 | 10.7 |

As one might expect, the oxidative stability of the CFSO without any added antioxidants was quite low at only 0.8 hours. The oxidative stability of the combined CV75-CFSO samples with added TBHQ was surprisingly high, though. Even with an ALA content over 19 wt %, sample A5 had an OSI of 23 hours. Better yet, sample A4 had an OSI over 32 hours despite having over 14 wt % ALA.

One particularly interesting aspect of the data is the relatively stable OSI values across samples A2-A4. As illustrated in FIG. 1, this represents a plateau in OSI value at a range of ALA values from 9.7 wt % to 14.3 wt %. Such a plateau suggests that a manufacturer may be able to make edible fats in accordance with this particular embodiment that have a fairly consistent oxidative stability despite some variations in ALA content from one production run to another.

### Example 2

### Canola/Flaxseed Blends

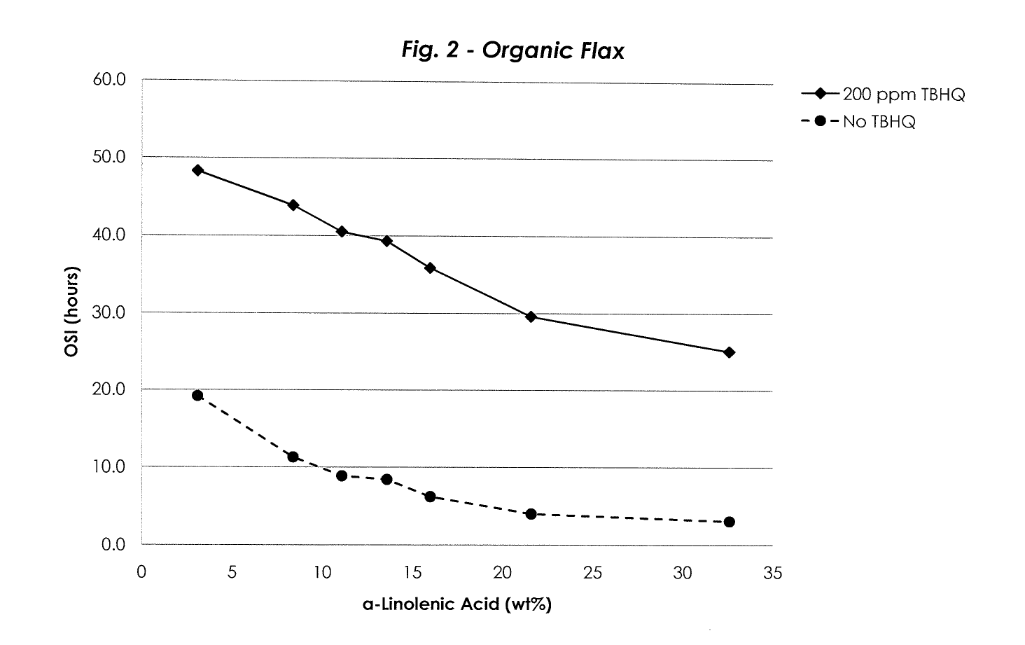

Much the same process as Example 1 was used to determine the performance of cold-pressed organic flaxseed oil (OFSO in Table 2) in edible fats in accordance with the disclosure. The results are set forth in Table 2 and illustrated graphically in FIG. 2.

TABLE 2

| | CV75 | OFSO | ALA | OSI (hours) | OSI (hours) |
|---|---|---|---|---|---|
| Sample | (wt %) | (wt %) | (wt %) | Oil only | 200 ppmTBHQ |
| CV75 | 100 | 0 | 3.1 | 19.2 | 48.3 |
| B1 | 90 | 10 | 8.4 | 11.3 | 43.9 |
| B2 | 85 | 15 | 11.1 | 8.9 | 40.5 |
| B3 | 80 | 20 | 13.6 | 8.5 | 39.3 |
| B4 | 75 | 25 | 16.0 | 6.3 | 35.9 |
| B5 | 65 | 35 | 21.6 | 4.1 | 29.6 |
| B6 | 44 | 56 | 32.6 | 3.1 | 25.1 |
| OFSO | 0 | 100 | | 1.1 | |

The results for this test were even more impressive than those in Example 1. Even with more than 32 wt % ALA, sample B6 had an OSI value of over 25 hours with TBHQ and sample B2 with TBHQ produced an OSI value over 40 hours with greater than 11 wt % ALA.

### Example 3

### Ready-to-Eat Cereal

Some food products, e.g., crackers, nuts, and dried fruits, are routinely sprayed with oil for a variety of reasons. Shelf-life stability was tested for a ready-to-eat cereal coated with a high-ALA oil in accordance with an embodiment of the invention.

In particular, each of four batches of CHEERIOS brand oat cereal (General Mills, Minneapolis, Minn. USA) was homogeneously sprayed with one of the four following canola/flaxseed oil blends:
Batch 3.1 was sprayed with “ALA 30-TBHQ”, which included 56 wt % cold-pressed flaxseed oil, 44 wt % CV-75 canola oil, and 200 ppm (weight basis) of TBHQ.
Batch 3.2 was sprayed with “ALA 30-RA”, which included 55.8 wt % cold-pressed flaxseed oil, 43.9 wt % CV-75 canola oil, and 0.3 wt % of an antioxidant blend of rosemary extract and ascorbic acid sold by Kalsec Inc. of Kalamazoo, Mich.
Batch 3.3 was sprayed with “ALA 20-TBHQ”, which included 35 wt % cold-pressed flaxseed oil, 65 wt % CV-75 canola oil, and 200 ppm (weight basis) of TBHQ.
Batch 3.4 was sprayed with “ALA 20-RA”, which included 34.9 wt % cold-pressed flaxseed oil, 64.8 wt % CV-75 canola oil, and 0.3 wt % of the same antioxidant blend used in ALA 30-RA of Batch 3.2.

The target oil content of the sprayed cereal in each batch was 5 wt %. In actuality, Batches 3.1-3.3 contained 5.7 wt % of the oil and Batch 3.4 contained 5.2 wt % of the oil. For each batch, two 100 g samples of the sprayed cereal were placed in separate 500 g amber bottles. One of the bottled samples was incubated at 72° F.; the other was incubated at 90° F.

These bottled, coated cereals were tested monthly by sensory experts using a 10-point scale where a score of 1 reflects good sensory characteristics and a score of 10 is the worst. A sample is deemed to fail the sensory test if its sensory score is 7 or higher. In addition, the fat in a portion of the cereal was extracted on a monthly basis and its fatty acid composition was measured in accordance with AOCS Ce 1-62 (modified).

After two months of incubation, all four of the cereal samples retained a sensory score of 1 at both incubation temperatures, with no off notes being detected. Table 3A provides the measured fatty acid profile of the oil extracted for each of the 4 samples before incubation began, including the amount of ALA in one standard serving of the cereal. Table 3B provides the same information after one month of incubation for the samples incubated at 72° F. Table 3B provides the same information after one month of incubation for the samples incubated at 90° F. Each of the fatty acid profiles in the following tables, in this Example and others below, is stated as a weight percentage of the specified fatty acid moiety based on the total weight of fatty acid moieties in the fat.

TABLE 3A
(No Incubation)

| | Batch | Batch | Batch | Batch |
|---|---|---|---|---|
| | 3.1 | 3.2 | 3.3 | 3.4 |
| ALA mg/serv | 537.6 | 452.2 | 448.5 | 419.5 |
| C14:0 | 0.1 | 0.1 | 0.1 | 0.1 |
| C16:0 | 6.4 | 6.6 | 6.5 | 6.1 |
| C16:1 | 0.2 | 0.2 | 0.2 | 0.2 |
| C18:0 | 2.8 | 3.0 | 3.6 | 2.6 |
| C18:1 | 44.8 | 44.0 | 54.4 | 55.0 |
| C18:2 | 18.7 | 19.8 | 16.2 | 15.8 |
| C18:3 | 25.0 | 24.4 | 16.6 | 17.8 |
| C20:0 | 0.4 | 0.4 | 0.5 | 0.5 |
| C20:1 | 0.8 | 0.8 | 0.9 | 1.0 |
| C20:2 | 0.1 | 0.1 | 0.1 | 0.1 |
| C22:0 | 0.3 | 0.3 | 0.3 | 0.3 |
| C22:1 | 0.0 | 0.1 | 0.1 | 0.1 |
| C24:0 | 0.2 | 0.2 | 0.2 | 0.2 |
| C24:1 | 0.1 | 0.1 | 0.1 | 0.1 |
| Total Saturated | 10.2 | 10.5 | 11.3 | 9.8 |
| Fats | | | | |

TABLE 3B
(1 Month of Incubation at 72° F.)

| | Batch | Batch | Batch | Batch |
|---|---|---|---|---|
| | 3.1 | 3.2 | 3.3 | 3.4 |
| ALA mg/serv | 549.3 | 495.3 | 391.6 | 332.6 |
| C14:0 | 0.1 | 0.1 | 0.1 | 0.1 |
| C16:0 | 6.3 | 6.5 | 6.2 | 6.4 |
| C16:1 | 0.2 | 0.2 | 0.2 | 0.2 |
| C18:0 | 2.8 | 2.9 | 2.7 | 2.8 |
| C18:1 | 45.0 | 44.1 | 54.7 | 54.6 |
| C18:2 | 18.6 | 19.7 | 16.1 | 16.4 |
| C18:3 | 25.0 | 24.5 | 17.7 | 17.3 |
| C20:0 | 0.4 | 0.4 | 0.5 | 0.5 |
| C20:1 | 0.8 | 0.8 | 1.0 | 1.0 |
| C20:2 | 0.1 | 0.1 | 0.1 | 0.1 |
| C22:0 | 0.3 | 0.3 | 0.3 | 0.3 |
| C22:1 | 0.1 | 0.1 | 0.0 | 0.1 |
| C24:0 | 0.2 | 0.2 | 0.2 | 0.2 |
| C24:1 | 0.1 | 0.1 | 0.1 | 0.1 |
| Total Saturated | 10.1 | 10.4 | 10.0 | 10.3 |
| Fats | | | | |

TABLE 3C
(1 Month of Incubation at 90° F.)

| | Batch | Batch | Batch | Batch |
|---|---|---|---|---|
| | 3.1 | 3.2 | 3.3 | 3.4 |
| ALA mg/serv | 427.3 | 554.8 | 342.6 | 340.4 |
| C14:0 | 0.1 | 0.1 | 0.1 | 0.1 |
| C16:0 | 6.4 | 6.6 | 6.2 | 6.4 |
| C16:1 | 0.2 | 0.2 | 0.2 | 0.2 |
| C18:0 | 2.7 | 2.9 | 2.7 | 2.7 |
| C18:1 | 45.1 | 44.0 | 54.8 | 54.7 |
| C18:2 | 18.9 | 19.9 | 16.1 | 16.3 |
| C18:3 | 24.5 | 24.2 | 17.6 | 17.3 |
| C20:0 | 0.4 | 0.4 | 0.5 | 0.5 |
| C20:1 | 0.8 | 0.8 | 1.0 | 1.0 |
| C20:2 | 0.1 | 0.1 | 0.1 | 0.1 |
| C22:0 | 0.3 | 0.3 | 0.3 | 0.3 |
| C22:1 | 0.1 | 0.1 | 0.1 | 0.1 |
| C24:0 | 0.2 | 0.2 | 0.2 | 0.2 |
| C24:1 | 0.1 | 0.1 | 0.1 | 0.1 |
| Total Saturated | 10.2 | 10.5 | 10.0 | 10.3 |
| Fats | | | | |

Each of the samples tested had greater than 320 mg of ALA in a serving of the cereal, allowing them to be identified under current FDA guidelines as an “excellent” source of omega-3 fatty acids. Despite the high levels of ALA, the cereal demonstrated excellent shelf stability over the course of two months, even when incubated at 90° F.

### Example 4

### Fruit and Nut Bars

The shelf stability of fruit and nut bars was tested by first preparing two different batches of bars. Both batches were prepared the same way and using the same basic formula, but one batch (Batch 4.1) employed the ALA 30-TBHQ oil sprayed on Batch 3.1 in Example 3 and the other (Batch 4.2) employed the ALA 30-RA oil sprayed on Batch 3.2 in Example 3. Table 4 sets forth the formula for the bars, with “OIL” in the table referring to ALA 30-TBHQ for Batch 4.1 and referring to ALA 30-RA for Batch 4.2.

TABLE 4

| | Weight |
|---|---|
| Ingredient | (grams) |
| Dry Ingredients | |
| Granola Blend | 425.00 |
| Crisp Rice (Kerry Ingredients, Beloit, Wisconsin) | 106.25 |
| Raisins | 103.75 |
| Almonds | 87.50 |
| Roasted Peanuts | 50.00 |
| Sunflower Seeds | 18.75 |
| Cranberries (Jem Ingredients) | 18.75 |
| Binder | |
| Corn Syrup (CLEARSWEET HM 43 from Cargill, Incorporated) | 200.00 |
| Honey | 83.75 |
| Sugar (Cargill, Incorporated) | 37.50 |
| Fructose (Chicago Sweeteners) | 62.50 |
| OIL | 26.25 |
| Maltodextrin, (10 DE from Cargill, Incorporated) | 12.50 |
| Soy Lecithin (TOPCITHIN from Cargill, Incorporated) | 4.38 |
| Salt (TOPFLO from Cargill, Incorporated) | 6.25 |
| Vanilla Extract (McCormick & Company, Inc.) | 5.63 |
| Baking Soda | 1.25 |

The dry ingredients were mixed together in a bowl. In a separate pot, all of the binder ingredients except the vanilla extract were heated to 160° F., at which time the vanilla extract was mixed in. The binder was then mixed with the dry ingredients until the binder was relatively uniformly incorporated in the mass. The mass was sheeted onto a bar pan and rolled with a rolling pin until compressed. The compressed mass was allowed to cool and cut into 40-gram bars.

One set of bars from each of Batch 4.1 and Batch 4.2 was incubated at 72° F.; another set of the bars from each batch was incubated at 90° F. The bars were tested monthly by sensory experts using a 10-point scale where a score of 1 reflects good sensory characteristics and a score of 10 is the worst. A sample is deemed to fail the sensory test if its sensory score is 7 or higher.

After five months of incubation, all of the bars tested were deemed commercially acceptable at both incubation temperatures, with no off notes being detected. The bars contained 2.1 wt % of the ALA 30 oils, or 0.84 grams of the oil in each 40 mg bar, yielding bars with over 200 mg of ALA. Assuming each bar is a serving, they can be identified under current FDA guidelines as a “good” source of omega-3 fatty acids. Even with these elevated ALA levels, testing to date suggests that these bars will have excellent shelf life with either antioxidant tested.

### Example 5

### Baked Bread

Elevated temperatures tend to promote oxidation of fatty acids. Given that the oxidative stability of ALA is already relatively low, use of a fat with a higher ALA content in an elevated temperature application, e.g., in baked food products, can be particularly challenging.

Fats in accordance with one aspect of the invention were tested in baked bread. The bread was prepared having the composition shown in Table 5, which lists the ingredients in terms of actual weight, weight percentage of the total composition, and “baker's %”, which is a weight percentage based on the weight of the flour and salt in the formula. Two batches were prepared, differing only in the nature of the “ALA 30 oil” in Table 5—in one batch, the oil had the same formula as the ALA 30-TBHQ used in Batch 3.1 of Example 3; the oil in the other batch had the same formula as the ALA 30-RA used in Batch 3.2.

TABLE 5

| Ingredients | Weight (g) | Weight % | Bakers % |
|---|---|---|---|
| Artisan Bread Flour | 1153.0 | 55.65 | 97.88 |
| (Cargill, Incorporated) | | | |
| Salt | 25.0 | 1.21 | 2.12 |
| ALA 30 oil | 80.0 | 3.86 | 6.79 |
| Mono & Diglycerides | 6.0 | 0.29 | 0.51 |
| Dough Conditioner (IM-PROVE 200 | 13.0 | 0.63 | 1.10 |
| from Caravan Ingredients of | | | |
| Lenexa, Kansas) | | | |
| Fresh Compressed Yeast | 50.0 | 2.41 | 4.24 |
| High Fructose Corn Syrup 42 | 75.0 | 3.62 | 6.37 |
| Water (60° F.) | 670.0 | 32.34 | 56.88 |
| Totals | 2072.0 | 100.00 | 175.89 |

The ingredients were mixed in a Hobart A-200 mixer with a McDuffy mixing bowl (1-L, 12-M) with a finished dough product temperature of 80-82° F. The dough was cut into four 510 gram pieces and allowed to rest for 15 minutes prior to sheeting/moulding. The dough products were sheeted/moulded on a sheeter/moulder with the top sheeting roll on setting 2 and the bottom sheeting roll on setting 6. Each dough product was placed in a 10½″×5″×3⅜″ pan and the panned dough was placed in a proofing cabinet for 60 minutes at 110° F. and 95% relative humidity. The dough products were baked in a Reel oven with wire shelves at 425° F. for 28 minutes. The baked bread products were depanned and allowed to cool at room temperature.

The baked bread had no off flavors in 11 days of storage at room temperature. At that point, mold developed and testing was terminated. It is believed that even longer shelf life can be obtained by adding a conventional mold inhibitor.

The formula of this bread has at least 320 mg of ALA per serving, enabling it to be identified under current FDA guidelines as an “excellent” source of omega-3 fatty acids. One would expect that heating the high-ALA oils employed in this example to cause them to degrade and lead to off flavors. Surprisingly, though, baking at over 400° F. did not lead to off flavors in the freshly baked bread and no off flavors developed in over a week and a half at room temperature. Fats in accordance with aspects of the invention, therefore, show significant promise in adding omega-3 fatty acids to high-quality baked food products with commercially acceptable shelf lives.

### Example 6

### Baked Muffins

The stability of the oils used in Example 5 in baked food products was confirmed by testing in a baked muffin application. Four batches of muffins were prepared, each of which had the same general formula shown in Table 6A. The batches differed in the nature of the fat used as the “ALA Oil” listed in Table 6A: Batch 6.1 used the ALA 30-TBHQ fat mentioned in Example 3; Batch 6.2 used the ALA 30-RA fat mentioned in Example 3; Batch 6.3 used the ALA 20-TBHQ fat mentioned in Example 3; and Batch 6.4 used the ALA 20-RA fat mentioned in Example 3.

TABLE 6A

| | Weight % | Weight (g) |
|---|---|---|
| Dry Mix Ingredients | | |
| Sugar, regular | 37.10 | 1670 |
| Sugar, powdered | 1.64 | 74 |
| Dextrose | 4.00 | 180 |
| Salt | 0.70 | 32 |
| CV-65 | 0.50 | 23 |
| Lecithin UB | 0.30 | 14 |
| Polysorbate 60 | 0.10 | 5 |
| Emulsifier (Texture Lite) | 0.35 | 16 |
| CV-AP Shortening | 6.06 | 273 |
| Flour, Cake | 29.54 | 1329 |
| Flour, Spring Hearth | 8.70 | 392 |
| Non Fat Dry Milk | 5.25 | 236 |
| Starch, PolarTex 12640 | 3.44 | 155 |
| Soda | 0.66 | 30 |
| SALP BL-60 | 0.52 | 23 |
| SAPP #28 | 0.22 | 10 |
| MCP V-90 | 0.22 | 10 |
| Calcium Propionate | 0.40 | 18 |
| Xanthan Gum | 0.25 | 11 |
| SSL | 0.05 | 2 |
| | 100.00 | 4500 |
| Batter Recipe | | |
| Dry Mix | 50.91 | 2240 |
| Whole Eggs | 18.52 | 815 |
| CV-65 (Cargill, Incorporated) | 13.17 | 579 |
| ALA Oil | 2.70 | 119 |
| Water | 14.70 | 647 |
| | 100.00 | 4400 |

The dry mix ingredients were mixed together in a bowl to form the dry mix. Two volumes of this dry mix were prepared for a total of 9000 g of dry mix to be used for the four batches. A separate batter was formed for each of Batches 6.1-6.4 by mixing the liquid ingredients together, adding half of the liquid to the dry mix, and mixing in a Hobart mixer (1-L, 3-M), scraping the bowl between stages. The remaining liquid was then added and again mixed in the same mixer (1-L, 3-M) with the bowl scraped between stages. The batter was deposited in muffin pans with a #24 scoop and baked for 20 minutes at 375° F. to produce 72 muffins from each batch.

The muffins were packed in plastic containers, 6 muffins per container, and incubated at 72° F. for 21 days. Samples were tested by sensory experts on the first day (day 0) and every fourth day of incubation using the same 10-point scale used in Examples 3-5. Throughout the testing, muffins from all four batches had a sensory score of 1, with no off notes being detected.

At day 0 and day 20, the total fat content of one muffin from each batch was measured (AOCS Aa 4-38) and the fatty acid composition of extracted fat was tested (AOCS Ce 1-62 (modified)). Table 6B provides the fat content and the measured fatty acid profile of the extracted oil for each of the four samples at day 0 and Table 6C provides the same information after 20 days of incubation.

TABLE 6B
(Day 0)

| | Batch 6.1 | Batch 6.2 | Batch 6.3 | Batch 6.4 |
|---|---|---|---|---|
| Muffin Weight (g) | 38.6 | 39.3 | 39.2 | 39.0 |
| % Oil in muffin | 21.9 | 22.5 | 25.9 | 22.4 |
| ALA (mg/serv) | 520.6 | 534.2 | 493.8 | 434.4 |
| C14:0 | 0.1 | 0.1 | 0.1 | 0.1 |
| C16:0 | 6.1 | 6.4 | 6.3 | 6.0 |
| C16:1 | 0.4 | 0.4 | 0.4 | 0.4 |
| C18:0 | 4.6 | 4.4 | 4.8 | 4.5 |
| C18:1 | 59.9 | 60.3 | 61.6 | 61.6 |
| C18:2 | 20.2 | 20.1 | 19.2 | 19.8 |
| C18:3 | 6.2 | 6.0 | 4.9 | 5.0 |
| C20:0 | 0.6 | 0.5 | 0.6 | 0.6 |
| C20:1 | 1.1 | 1.0 | 1.1 | 1.1 |
| C20:2 | 0.1 | 0.1 | 0.1 | 0.1 |
| C22:0 | 0.3 | 0.3 | 0.3 | 0.3 |
| C22:1 | 0.1 | 0.0 | 0.0 | 0.1 |
| C24:0 | 0.2 | 0.1 | 0.2 | 0.2 |
| C24:1 | 0.1 | 0.1 | 0.3 | 0.1 |
| Total Saturated Fats | 12.0 | 11.9 | 12.4 | 11.8 |

TABLE 6C
(Day 20)

| | Batch 6.1 | Batch 6.2 | Batch 6.3 | Batch 6.4 |
|---|---|---|---|---|
| Muffin Weight (g) | 39.3 | 39.5 | 39.2 | 39.0 |
| % Oil in muffin | 23.0 | 21.6 | 25.9 | 22.4 |
| ALA (mg/serv) | 443.9 | 419.2 | 493.8 | 434.4 |
| C14:0 | 0.1 | 0.1 | 0.1 | 0.1 |
| C16:0 | 6.3 | 6.3 | 6.3 | 6.0 |
| C16:1 | 0.4 | 0.4 | 0.4 | 0.4 |
| C18:0 | 4.4 | 4.4 | 4.8 | 4.5 |
| C18:1 | 62.1 | 62.1 | 61.6 | 61.6 |
| C18:2 | 19.5 | 19.5 | 19.2 | 19.8 |
| C18:3 | 4.9 | 4.9 | 4.9 | 5.0 |
| C20:0 | 0.5 | 0.5 | 0.6 | 0.6 |
| C20:1 | 1.0 | 1.0 | 1.1 | 1.1 |
| C20:2 | 0.1 | 0.1 | 0.1 | 0.1 |
| C22:0 | 0.3 | 0.3 | 0.3 | 0.3 |
| C22:1 | 0.0 | 0.0 | 0.0 | 0.1 |
| C24:0 | 0.1 | 0.1 | 0.2 | 0.2 |
| C24:1 | 0.1 | 0.1 | 0.3 | 0.1 |
| Total Saturated Fats | 11.8 | 11.8 | 12.4 | 11.8 |

This example further emphasizes the surprising ability of fats in accordance with aspects of the invention to add significant amounts of ALA to baked food products without unduly compromising shelf life. Assuming a 40 g serving size, each of these muffins qualifies under current FDA guidelines as an “excellent” source of omega-3 fatty acids, having well in excess of the requisite 320 mg. Even after baking at over 350° F. for over 15 minutes, the muffins showed remarkable stability over the course of three full weeks.

### Example 7

### Baked Cookies

Utility of all-purpose shortenings in accordance with aspects of the invention was tested in baked sugar cookies. Each of three test shortenings, designated S3, S11, and S17, were prepared by mixing melted oil, votating, and storing for 72 hours in a tempering room maintained at 70° F. The S3 shortening included 83 wt % CV65 and 17 wt % fully hydrogenated cottonseed oil. The S11 shortening included 66 wt % CV65, 17 wt % cold-pressed flaxseed oil, 17 wt % fully hydrogenated cottonseed oil, and 0.3% of an antioxidant blend of rosemary extract and ascorbic acid sold by Kalsec Inc. of Kalamazoo, Mich. The S17 shortening included 53 wt % CV65, 30 wt % cold-pressed flaxseed oil, 17 wt % fully hydrogenated cottonseed oil, and 0.3% of the same antioxidant blend of rosemary extract and ascorbic acid.

The OSI values and fatty acid profiles for each of these three shortening is set forth in Table 7A. As noted previously, the OSI measurements were carried out in accordance with AOCS Cd 12b-92 at 110° C. with a 743 RANCIMAT® analyzer, but with a 3 g sample size.

TABLE 7A

| | S3 | S11 | S17 |
|---|---|---|---|
| OSI (hours) | 14.38 | 64.91 | 40.16 |
| C14:0 | 0.17 | 0.17 | 0.18 |
| C16:0 | 7.46 | 7.65 | 7.83 |
| C16:1 | 0.27 | 0.22 | 0.20 |
| C18:0 | 13.76 | 14.19 | 14.45 |
| C18:1 | 54.54 | 46.38 | 40.42 |
| C18:2 | 18.81 | 17.77 | 16.87 |
| C18:3 | 2.5 | 11.43 | 18.22 |
| C20:0 | 0.6 | 0.52 | 0.46 |
| C20:1 | 1.02 | 0.85 | 0.70 |
| C20:2 | 0.07 | 0.10 | 0.05 |
| C22:0 | 0.34 | 0.32 | 0.30 |
| C22:1 | 0.04 | 0.04 | 0.01 |
| C24:0 | 0.28 | 0.25 | 0.22 |
| C24:1 | 0.15 | 0.11 | 0.09 |
| Total Saturated Fats | 22.6 | 23.11 | 23.44 |

Larger, 200-pound batches of each of these three same shortening compositions were prepared using the same basic process, but in a pilot scale production environment instead of a laboratory. Table 7B sets forth the fatty acid profiles and solid fat content at 10° C. for each of these three shortenings. The formulas for shortenings PS3, PS11, and PS17 in Table 7B correspond to those for S3, S11, and S17, respectively. Again, the OSI measurements were carried out in accordance with AOCS Cd 12b-92 at 110° C. with a 743 RANCIMAT® analyzer, but with a 3 g sample size; the solid fat content (“SFC10” in Table 7B) was determined in accordance with AOCS Cd 16b-93.

TABLE 7B

| | PS3 | PS11 | PS17 |
|---|---|---|---|
| C12:0 | 0.03 | 0.02 | 0.02 |
| C14:0 | 0.15 | 0.14 | 0.15 |
| C15:0 | 0.00 | 0.00 | 0.00 |
| C16:0 | 7.05 | 7.10 | 7.37 |
| C16:1 | 0.21 | 0.18 | 0.15 |
| C17:0 | 0.08 | 0.09 | 0.01 |
| C18:0 | 13.49 | 14.41 | 15.08 |
| C18:1 total | 54.82 | 46.46 | 39.87 |
| C18:1 trans | 0.00 | 0.00 | 0.00 |
| C18:2 cis | 18.86 | 17.56 | 16.47 |
| C18:2 total | 19.09 | 17.79 | 16.68 |
| C18:2 trans | 0.21 | 0.20 | 0.20 |
| C18:3 cis | 2.31 | 11.46 | 18.62 |
| C18:3 total (ALA) | 2.60 | 11.74 | 18.89 |
| C18:3 trans | 0.29 | 0.28 | 0.27 |
| C20:0 | 0.61 | 0.52 | 0.44 |
| C20:1 | 1.04 | 0.85 | 0.70 |
| C22:0 | 0.35 | 0.30 | 0.26 |
| C24:0 | 0.18 | 0.15 | 0.15 |
| Trans-fatty acid | 0.65 | 0.65 | 0.62 |
| SFC10 | 17.51 | 18.25 | 19.07 |

Three 1.5 kg batches of sugar cookie dough were prepared using composition shown in Table 7C, with each of S3, S11, and S17 being used as the shortening in one of the batches. “B&V Flavor” in Table 7C refers to a commercial butter and vanilla flavor blend.

TABLE 7C

| Ingredient | Weight (g) | Weight % |
|---|---|---|
| Sugar, regular | 460.2 | 30.68 |
| Shortening | 277.8 | 18.52 |
| Salt | 9.0 | 0.60 |
| Baking Soda | 4.5 | 0.30 |
| B&V Flavor | 2.6 | 0.17 |
| Whole Eggs | 115.4 | 7.69 |
| Whole Milk | 75.0 | 5.00 |
| Cake Flour | 277.8 | 18.52 |
| Artisan Bread Flour | 277.8 | 18.52 |
| Totals: | 1500.0 | 100.00 |

The density of each batch of dough was measured and cookies from each batch were deposited on a cooking sheet using a #30 scoop. The deposited cookies were baked for 12 minutes at 400° C. The spread (diameter), height, moisture content, and texture were measured for 6 baked cookies from each batch. The texture was measured (in grams of force) in a three-point bend test using a TA-XT2i Texture Analyzer, available from Texture Technology Corp., Scarsdale, N.Y., USA. Table 7D sets forth the results of these tests, with the results for the 6 cookies from each sample being averaged in reporting the results for spread, height, finished moisture, and texture.

TABLE 7C

| | S3 | S11 | S17 |
|---|---|---|---|
| | cookies | cookies | cookies |
| Dough Density (g/ml) | 1.03 | 1.01 | 1.01 |
| Spread (cm) | 7.73 | 7.80 | 7.83 |
| Height (cm) | 1.28 | 1.13 | 1.13 |
| Finished Moisture (%) | 8.40 | 8.80 | 8.80 |
| 3-Point Bend Test (g. | 420.2 | 282.4 | 257.8 |
| force) | | | |

The dough density, spread, and height of the three batches of cookies were similar, but the cookies prepared with S11 and S17, which included flaxseed oil, had a softer texture than the cookies prepared with S3, which did not include flaxseed oil. All three shortenings appear to provide good functionality. Although the S11 and S17 shortenings were noticeably more yellow than the S3 shortening, the finished cookie crumb was similar in all three batches.

As detailed above, aspects of the invention provide fats with elevated levels of ALA that exhibit excellent oxidative stability. These fats have proven to be useful in food products that subject the fats to elevated temperatures, such as during baking, without compromising sensory characteristics or shelf life.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

1. An edible, non-hydrogenated fat having at least 10 weight percent (wt %) α-linolenic acid (ALA), no more than 10 wt % saturated fatty acids, and an Oxidative Stability Index at 110° C. (OSI) of at least 25 hours.

2. An edible, non-hydrogenated fat having at least 10 weight percent (wt %) α-linolenic acid (ALA) and an Oxidative Stability Index at 110° C. (OSI) of at least 25 hours, the fat comprising a combination of:
a first fat having no more than 5 wt % ALA;
a second fat having at least 40 wt % ALA; and
an antioxidant.

3. The edible, non-hydrogenated fat of claim 2 wherein the OSI is at least 28 hours.

4. The edible, non-hydrogenated fat of claim 2 wherein the OSI is at least 30 hours.

5. The edible, non-hydrogenated fat of claim 2 wherein the first fat is rapeseed oil.

6. The edible, non-hydrogenated fat of claim 2 wherein first fat is rapeseed oil having at least 67 wt % oleic acid and no more than 4 wt % ALA.

7. An edible fat comprising a combination of a) rapeseed oil, b) flaxseed oil, and c) an antioxidant, wherein the edible fat has an Oxidative Stability Index at 110° C. (OSI) of at least 25 hours and contains at least 10 wt % α-linolenic acid (ALA) and no more than 10 wt % saturated fatty acids.

8. The edible fat of claim 7 wherein the rapeseed oil contains at least 67 wt % oleic acid.

9. The edible fat of claim 7 wherein the rapeseed oil contains 70-80 wt % oleic acid.

10. The edible fat of claim 2 wherein the edible fat includes 0-0.1 wt % eicosapentaenoic acid and 0-0.1 wt % docosahexaenoic acid.

11. A food product comprising the edible fat of claim 2.

12. A food product comprising an edible, non-hydrogenated fat having at least 7.5 weight percent (wt %) α-linolenic acid (ALA), no more than 10 wt % saturated fatty acids, and an Oxidative Stability Index at 110° C. (OSI) of at least 25 hours.

13. The food product of claim 12 wherein the food product contains at least 160 mg of ALA per FDA reference serving size of the food product.

14. The food product of claim 12 wherein the food product contains at least 320 mg of ALA per FDA reference serving size of the food product.

15. An edible baked food product formed by baking a composition at a temperature of at least 350° F. for at least 15 minutes, the composition including an edible, non-hydrogenated fat comprising a) rapeseed oil having at least 63 weight percent (wt %) oleic acid, b) flaxseed oil, and c) an antioxidant, wherein the edible, non-hydrogenated fat has at least 10 weight percent (wt %) α-linolenic acid (ALA) and an Oxidative Stability Index at 110° C. (OSI) of at least 25 hours.

16. The baked food product of claim 15 wherein the baked food product contains at least 160 mg of ALA per 40 g of the baked food product.

17. The baked food product of claim 15 wherein the baked food product contains at least 320 mg of ALA per 40 g of the baked food product.

18. The baked food product of claim 15 wherein the OSI is at least 28 hours.

19. The baked food product of claim 15 wherein the OSI is at least 30 hours.

20. A method of making an edible baked food product, comprising:
mixing a composition comprising a first food ingredient and an edible, non-hydrogenated fat comprising a) rapeseed oil, b) flaxseed oil, and c) an antioxidant, wherein the edible, non-hydrogenated fat has at least 10 weight percent (wt %) α-linolenic acid (ALA) and an Oxidative Stability Index at 110° C. (OSI) of at least 25 hours; and
baking the composition at a temperature of at least 350° F. for at least 15 minutes.
